(19) United States
(12) Patent Application Publication
(10) Pub. No.: US 2007/0284851 A1
(43) Pub. Date: Dec. 13, 2007

(54) POWERED TOWING TONGUE

(76) Inventors: Justin Todd Adcock, Sullivan, IL (US); Neil Edwin Bowsher, Sullivan, IL (US)

Correspondence Address: Angelo J. Bufalino, Esq.;Vedder Price Kaufman & Kammholz, P.C., Suite 2600, 222 N. LaSalle Street, Chicago, IL, 60601, US

(21) Appl. No.: 11/422,849

(22) Filed: Jun. 7, 2006

(51) Int. Cl. B60D 1/44

(52) U.S. Cl. 280/448

(57) ABSTRACT

The present disclosure relates to a powered towing tongue, and more particularly, to an actuated power tongue consisting of at least two tongue members joined directly or indirectly by an actuator for moving a mount located in the back of a towing hitch from a first position to at least a second position along a radial path. In a second embodiment, the actuated power tongue is attached to a strap joining the at least two tongue members to move the mount located behind a towing hitch from a first position to at least a second position along a radial path commonly referred to as a lateral displacement.

### FIELD OF THE DISCLOSURE

The present disclosure relates to a powered towing tongue, and more particularly, to an actuated power tongue consisting of at least two tongue members joined directly or indirectly by an actuator for moving a mount relative to a tongue hitch from a first positions to a second position.

### BACKGROUND

A wide variety of motorized vehicles are used to tow implements, such as tugboats used for moving cargo boats, large farm tractors used for moving farming equipment, road preparation apparatus used for pulling asphalt containers, cars used for pulling trailers and caravans, and small lawn tractors used for pulling lawn equipment.

In some cases, a function is performed by the tow implement and the function may require for the implement be located at a precise position relative to the towing vehicle. In other cases, the position of the implement must be controlled to obtain a desired result from the tow implement. Tow implements are typically pulled from the back of towing vehicles. A rigid or articulated tongue is used to connect the vehicle to the implement. FIG. 1 shows one possible towing tongue used to attach a towing vehicle, such as a motorized lawn tractor, to a tow implement such as a plug aerator, a cart, a harvester, or a loose material enclosure. FIG. 1 shows a rigid or articulated system that includes a pivot to allow the tow implement to move along a radial path in the back of the tow vehicle as the angular position of the towing tongue changes. In the prior art, this device does not allow for control of the position of the implement in the back of the towing vehicle.

A plurality of existing devices use actuators to move the tow implement to help tow vehicle drivers position the tow implement. It is understood by one of ordinary skill in the art that while the disclosure hereafter describes lateral movements of tow implements in relation to tow vehicles, the tow implement movement in fact generally relates to a path along a radial curve at a fixed distance from the towing vehicle.

Some prior art devices place the actuator on the tow implement and actuate the towing tongue at some point along the length of the towing tongue in a direction almost perpendicular to the axis of the tongue. The disadvantages of this configuration include but are not limited to the need to equip each tow element with a different actuator and the need to use a powerful actuator based on a loss in efficiency relating to a force almost perpendicular to the axis of the actuator. A second group of prior art devices use an actuator attached on the tow vehicle to actuate the towing tongue at some point along the length of the towing tongue. Once again, one disadvantage of this configuration is the requirement that the actuated element of the towing tongue be mechanically coupled with the towing vehicle.

A need exists for a simple, compact, and easy-to-maintain actuated towing tongue with an actuator decoupled from either the towing vehicle or the tow implement and able to change the position of the tow vehicle relative to the tow implement.

### SUMMARY

The present disclosure relates to a powered towing tongue, and more particularly, to an actuated power tongue consisting of at least two tongue members joined directly or indirectly by an actuator for moving a mount located in the back of a towing hitch from a first position to at least a second position along a radial path. In a second associated embodiment, the actuated power tongue is attached to a strap joining the at least two tongue members to move the mount located behind a towing hitch from a first position to at least a second position along a radial path commonly referred to as a lateral displacement.

The disclosure provides for a towing tongue equipped with its own actuator to create a lateral shear force in the towing tongue to create a gradual lateral translation of a tow implement if the lateral friction force is inferior to the shear force and to create a gradual lateral translation of the tow implement during advancement of the tow vehicle.

### BRIEF DESCRIPTION OF THE DRAWINGS

FIG. 1 is a top view of an unpowered towing tongue as disclosed in the prior art.

FIG. 2 is a perspective view of the powered towing tongue according to a first embodiment.

FIG. 3 is an exploded perspective view of the powered towing tongue of FIG. 2.

FIG. 4 is a top view of the powered towing tongue of FIG. 2 in a third position.

FIG. 5 is a top view of the powered towing tongue of FIG. 2 in a first position.

FIG. 6 is a top view of the powered towing tongue of FIG. 2 in a second position.

FIG. 7 is a perspective view of the powered towing tongue according to a second embodiment.

FIG. 8 is a top view of the powered towing tongue of FIG. 7 in a third position.

FIG. 9 is a top view of the powered towing tongue of FIG. 7 in a first position.

FIG. 10 is a top view of the powered towing tongue of FIG. 7 in a second position.

### DETAILED DESCRIPTION

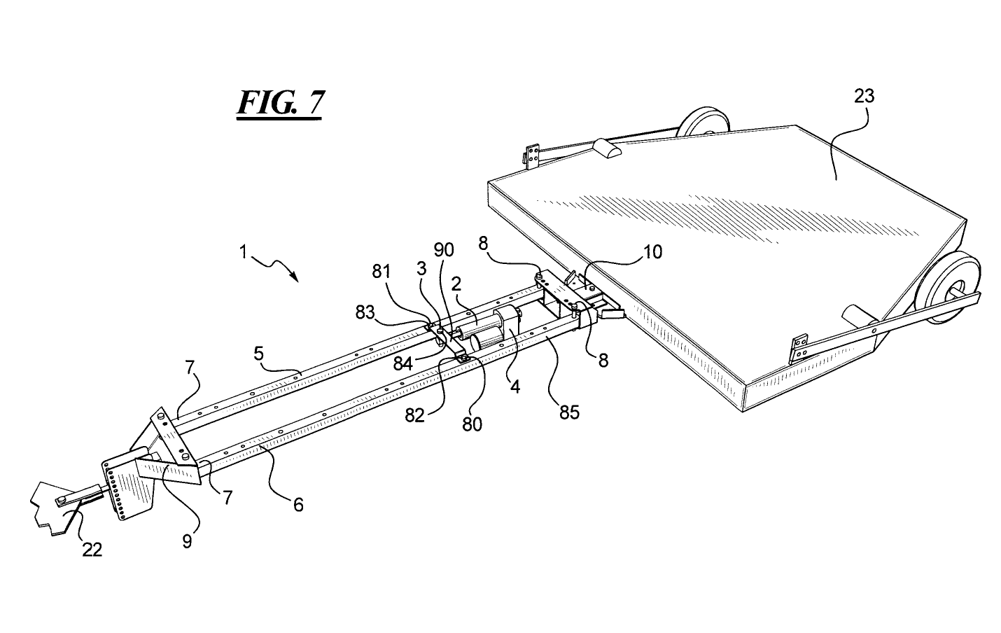

The present disclosure relates to a powered towing tongue, and more particularly, to an actuated power tongue consisting of at least two tongue members joined directly or indirectly by an actuator for moving a mount located in the back of a towing hitch from a first positions to at least a second position along a radial path. A first possible embodiment is illustrated in FIGS. 2-6 where the actuator is joined directly to the two tongue members. In a second possible embodiment as illustrated in FIGS. 7-10, the actuator is joined indirectly to the two tongue members by a strap.

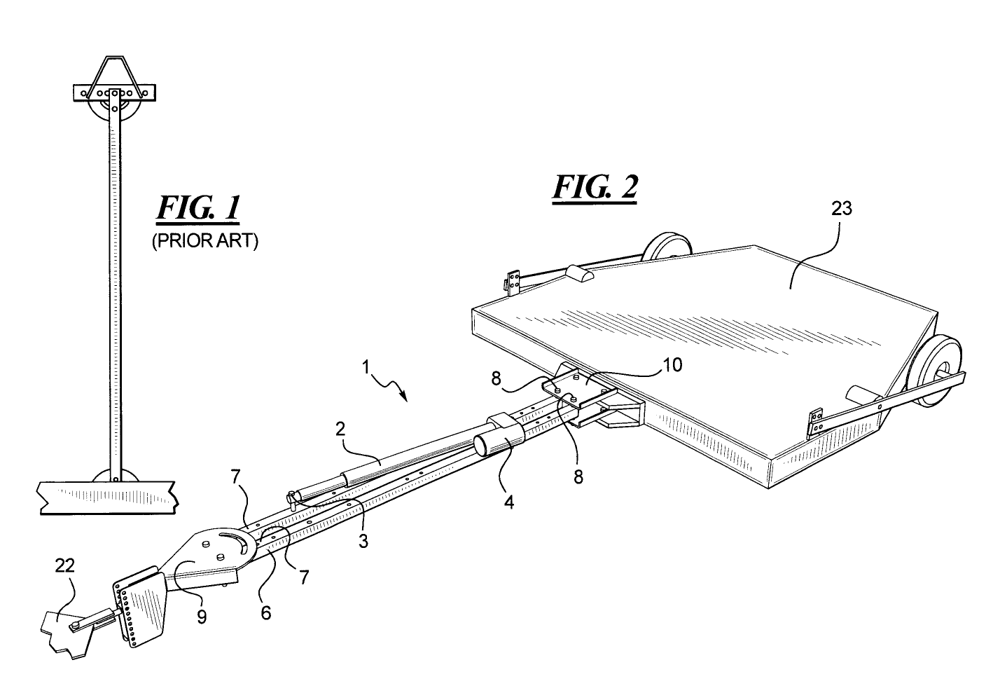

The possible disclosed embodiments shown in FIGS. 2-10 work on the same essential mechanical principle. The towing member 1 is made of a quadrilateral polygon where opposing sides are maintained essentially parallel, sides are not deformed, and corners pivot to allow the polygon to change in shape. An actuator 2 is used to control the distance L between any two points on the polygon. By controlling the distance between any two points on this type of polygon, two opposing sides move laterally from each other if one of the side is fixed. As shown in FIGS. 4-6 and 8-10 and referring to FIG. 1, if the tongue hitch 9 is fixed behind a towing vehicle 22 and an actuator 2 reduces or increases the distance L between two point on tongue members 5, 6, then the mount 10 moves laterally and changes the position of the tow implement 23 in relation to the towing vehicle 22. It is understood by one of ordinary skill in the art that while two possible embodiments are disclosed with a control over the distance L at two points on the polygon, other possible functional variations based on this principle are contemplated.

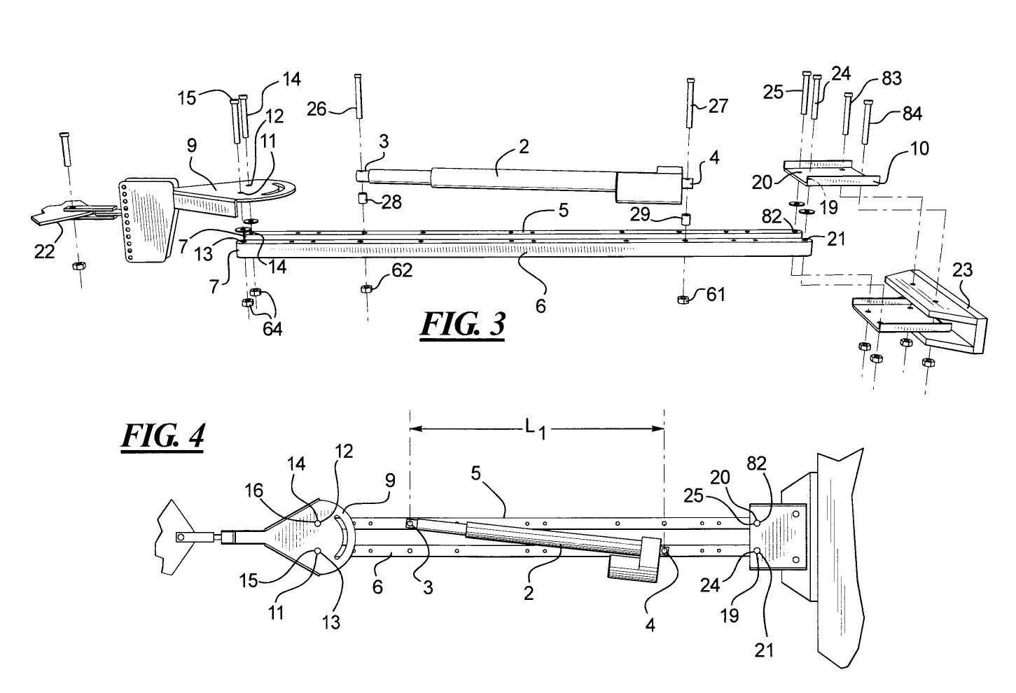

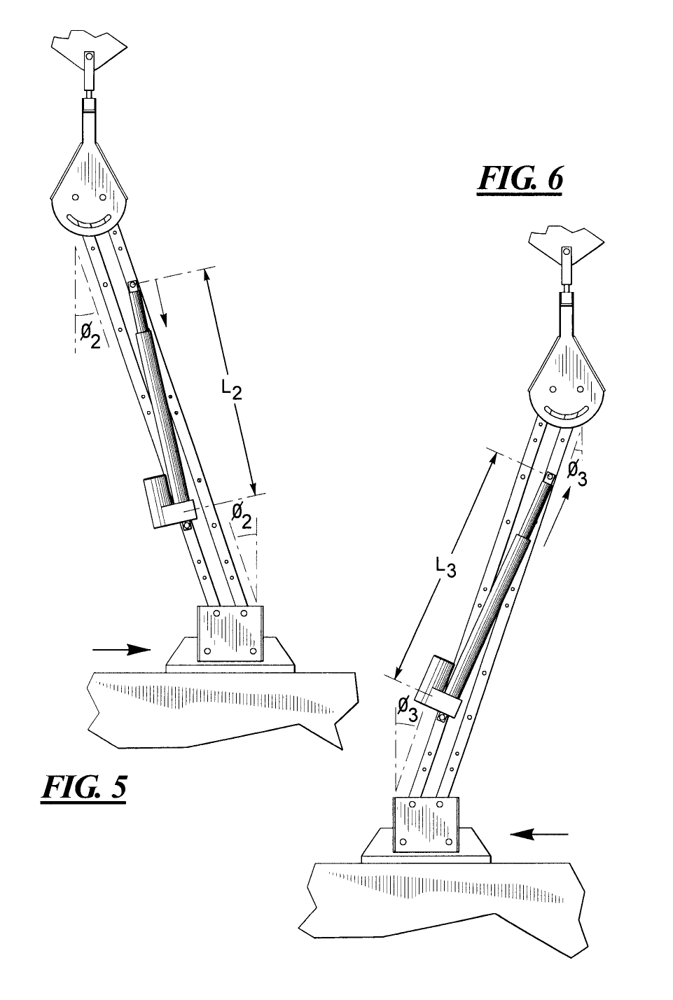

FIG. 2 is a perspective view of the powered towing tongue 1 according to a first embodiment. The towing tongue 1 comprises an actuator 2 with a first end 3 and a second end 4, a first tongue member 5 as shown in FIG. 3, and a second tongue member 6 as shown in FIG. 2. Each tongue member 5, 6 has a proximate first end 7, and a proximate second end 8. The towing tongue 1 also comprises a tongue hitch 9 and a mount 10 wherein the first end of the actuator 3 is movably connected to the first tongue member 5 and the second end of the actuator 4 is movably connected to the second tongue member 6. In addition, the tongue hitch 9 is movably connected to the proximate first ends 7 of the first and second tongue members 5, 6, and the mount 10 is movably connected to the proximate second ends 8 of the first and second tongue members 5, 6, respectively. The actuator 2, if operated, extends and retracts, forcing the first end 3 to move comparatively to the second end 4. As a consequence, the towing tongue 1 is operable between a first position shown in FIG. 5 and a second position shown in FIG. 6. FIG. 4 shows a third intermediate position located between the first and the second operating positions.

FIG. 4 shows a third configuration where the tongue hitch 9 and the mount 10 are aligned in a towing direction and where the towing tongue 1 creates a regular polygon where all four sides create right angles. The distance between both ends of the actuator 2 is shown as L2. FIG. 5 illustrates a first position where the actuator 2 has retracted and is now of effective length L2. As a result of the change in distance between the two ends of the actuator 2, the polygon deforms and an angle Φ2 is created between the towing vehicle 22 and the tow implement 23. FIG. 6 illustrates a second position where the actuator 2 has extended and is of effective length L2. As a result of this change in distance between the two ends of the actuator 2, the polygon deforms and an angle Φ3 is created between the towing vehicle 22 and the tow implement 23.

FIG. 2 shows a possible first embodiment where the actuator 2 is located on the top section of the two tongue members 5, 6. Depending on the actual distance between the two tongue members 5, 6 and other geometrical parameters including but not limited to the thickness and geometry of the tongue members 5, 6, the actuator 2 may be located between, under, on either side of the tongue members 5, 6, or at any other reasonable location so long as the first end 3 of the actuator 2 is able to be effectively mechanically linked or movably connected to the first tongue member 5 and the second end 4 of the actuator 2 is effectively or mechanically aligned with or movably connected to the second tongue member 6. It is understood by one of ordinary skill in the art that a wide variety of possible configurations may be conceived where the actuator 2 is able to ultimately control the distance L between two points on the polygon.

The actuator shown of FIG. 2 is a single-section, linear hydraulic actuator with a small fluid capacity and the associated motor. It is understood by one of ordinary skill in the art that other types of actuators may be used to regulate the distance between two points on the first tongue member 5 and the second tongue member 6, including but not limited to a pneumatic actuator, a mechanical actuator, a winch, a multisection actuator, or any other type of actuating device used directly or in association with a mechanical connection piece to create an actuating force. The disclosure does not show a control and command mechanism associated with the actuator since it is understood by one of ordinary skill in the art that any type of power source and associated connectors in association with the actuation of a single actuator 2 may be used along with a control device to be placed either at the location or remotely attached to the tow vehicle or the tow implement. It is be understood by one of ordinary skill in the art that any control and command system used in conjunction with the towing tongue 1 may include any of several basic functions in the art of actuation, including but not limited to the change in the length of the actuator 2, a push to maintain the actuator 2 in a fully open position or a fully closed position, a lock of the actuator 2 in any one of a plurality of positions, including a first, a second, or a third position situated between the first and the second position, or any other control and actuation commands commonly used in the art.

FIG. 2 shows two tongue members 5, 6 held in an essentially parallel position. It is understood by one of ordinary skill in the art that the section of the tongue members 5, 6 may be different and include any functional equivalent including but not limited to an I-profile or a C-profile. In addition, the tongue members 5, 6 may not be parallel to each other. For example, the tongue members may be curved to create a center opening where the actuator 2 may be inserted.

In another embodiment as shown in FIG. 3, the tongue hitch 9 may include a first aperture 11 and a second aperture 12 and the first and second tongue members 5, 6 may include corresponding apertures 13, 14 proximate to the first ends 7 of the first and second tongue members 5, 6. A first substantially vertical pivot axis shown as being perpendicular to the plane formed by the tongue hitch 9 is defined by a first hitch pin 15 positioned within the first aperture 11 and corresponding aperture 13 associated with the first tongue member 5, and a second substantially vertical pivot axis shown as being perpendicular to the plane formed by the tongue hitch 9 is defined by a second hitch pin 16 positioned within the second aperture 12 and corresponding aperture 14 associated with the second tongue member 6. In another embodiment, the tongue hitch 9 is connectable to a tow vehicle 22 and the mount 10 is connectable to a tow implement 23.

To demonstrate how a change in the length of the actuator 2 results in a change in the angular position of the tongue hitch 9 relative to the mount 10, FIGS. 5, 6, and 7 illustrate three different angular positions shown as Φ2 and Φ3 in FIGS. 6 and 7, respectively, and three different lengths of the actuator 2 shown as L1, L2, and L2 in FIGS. 5, 6, and 7, respectively. If the actuator 2 shown on FIG. 5 is shortened from L1 to L2, the towing tongue 1 changes from the configuration shown in FIG. 5 to the configuration shown in FIG. 6. If the actuator 2 as shown in FIG. 5 expands from L1 to L3, the towing tongue 1 changes from the configuration shown in FIG. 5 to the configuration shown in FIG. 7.

In yet another embodiment as shown in FIG. 3, the mount 10 may include a third and a fourth aperture 19, 20 and the first and second tongue members 5, 6 may include corresponding apertures 21, 82 proximate to the second ends 8 of the first and second tongue members 5, 6. A third substantially vertical pivot axis shown as being perpendicular to the plane formed by the mount 10 is defined by a first mount pin 24 positioned within the fourth aperture 19 and corresponding aperture 21 associated with the first tongue member 5, and a fourth substantially vertical pivot axis shown as being perpendicular to the plane formed by the mount 10 is defined by a second mount pin 25 positioned within the fourth aperture 20 and corresponding aperture 82 associated with the second tongue member 6.

FIG. 3 shows an embodiment where the actuator 2 is movably connected to the first tongue member 5 at a first end 3 with a first actuator pin 26 and a fixation means, such as a bolt 62. A spacer 28 may also be used between the first actuator end 3 and the first tongue member 5 to control the position of the first end 3. The actuator 2 may also be movably connected on the second tongue member 6 at a second end 4 with a second actuator pin 27 and a fixation means, such as a bolt 61. A spacer 29 may also be used between the second actuator end 4 and the second tongue member 6 to control the position of the second end 4.

FIG. 3 also shows further details associated with possible embodiments such as a series of vertical control plates attached to the tongue hitch 9, a fixation bolt used to fix the tongue hitch to the towing vehicle 22, and a plurality of fixation means, such as bolts 83, 84. While these details are disclosed, it is understood by one of ordinary skill in the art that a plurality of functional equivalents are contemplated to mechanically connect these elements.

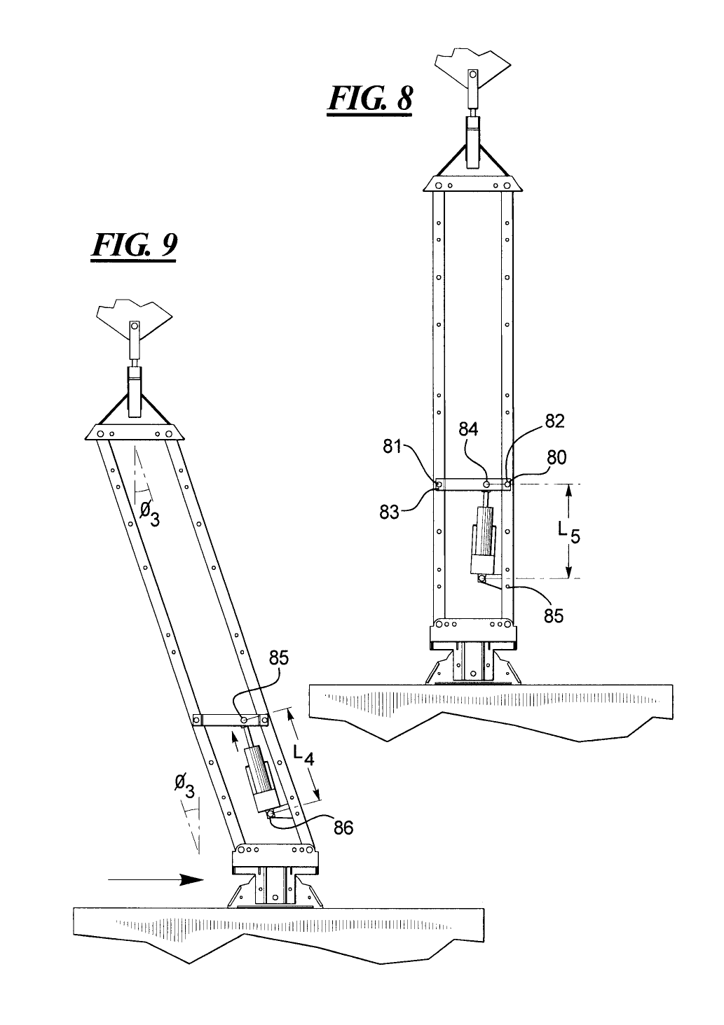

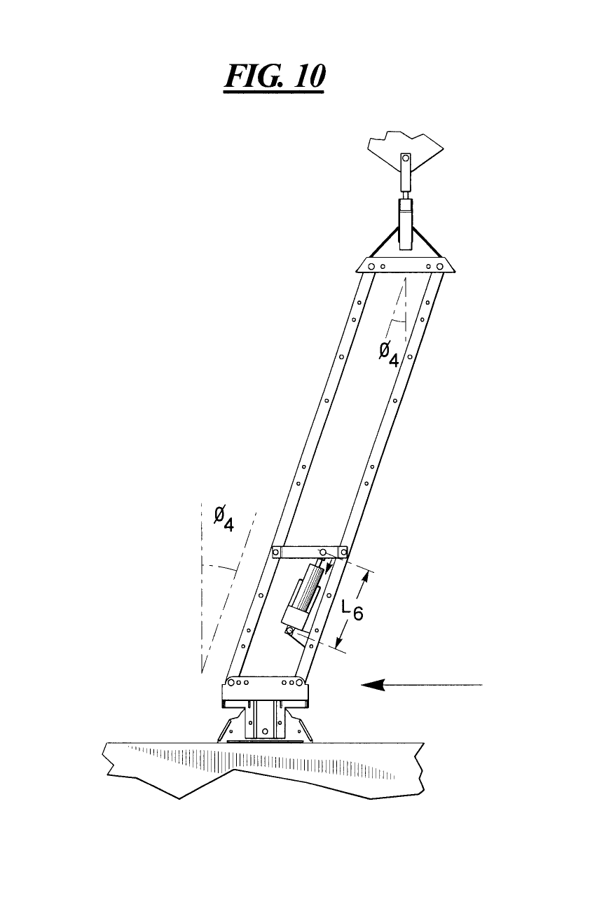

In another embodiment shown as FIG. 7, the towing tongue 1 comprises an actuator 2 with a first end 3 and a second end 4, first and second tongue members 5, 6 with a proximate first end 7 and a proximate second end 8, and an intermediate position shown as 81 on the first tongue member 5 and shown as 80 on the second tongue member 6. The towing tongue 1 further comprises a tongue hitch 9, a mount 10, and a strap 90 with a first pivotal attachment 82, a second pivotal attachment 83, and a third pivotal attachment 84. In this embodiment, the first tongue member 5 further comprises a pivotal position 85 for movably connecting the second end 4 of the actuator 2 between the proximate second end 8 and the intermediate position 80, and the first end 3 of the actuator 2 is movably connected to the third pivotal attachment 84 of the strap 90, and the first pivotal attachment 82 of the strap 90 is movably connected to the intermediate position 80 of the second tongue member 6, and the second pivotal attachment 83 of the strap 90 is movably connected to the intermediate position 81 of the first tongue member 5. The tongue hitch 9 is movably connected to the proximate first ends 7 of the first and second tongue members 5, 6, and the mount 10 is movably connected to the proximate second end 8 of the first and second tongue members 5, 6. The actuator 2 is operable between a first and second operation position shown as FIGS. 9 and 10, respectively, including at least a third operating position shown in FIG. 8 between the first and second operating position.

FIG. 7 shows an embodiment where the actuator 2 is located between the two tongue members 5, 6 and where the actuator 2 is attached via a tab to the second tongue member 6 at the second end 4. It is understood by one of ordinary skill in the art that the disclosed configuration is only one possible configuration where the actuator 2 is movably connected to the towing tongue 1. A method of fixation of the two towing members 5, 6 to the tongue hitch 9 and mount 10 for the embodiment shown on FIG. 7 is disclosed in FIG. 3. This embodiment also is able to swing about the tongue hitch 9 to any number of angular positions. To demonstrate how a change in the length of the actuator 2 results in a change in the angular position of the tongue hitch 9 relative to the mount 10 for this embodiment, FIGS. 8, 9, and 10 illustrate three different angular positions shown as Φ4 and Φ5 in FIGS. 9 and 10, respectively, and three different lengths of the actuator 2 shown as L4, L5, and L6 on FIGS. 8, 9, and 10, respectively. If the actuator 2 as shown in FIG. 8 is shortened from L5 to L4, the towing tongue 1 changes from the configuration shown on FIG. 8 to the configuration shown on FIG. 9. If the actuator 2 as shown in FIG. 8 expands from L5 to L6, the towing tongue 1 changes from the configuration shown in FIG. 8 to the configuration shown in FIG. 10.

FIGS. 7-10 also disclose an embodiment where a linear actuator is shown, the first and second tongue members 5, 6 are substantially parallel to each other, the tongue hitch 9 is connectable to a tow vehicle 22, and the mount 10 is connectable to a towed implement 23.

Persons of ordinary skill in the art appreciate that although the teachings of the disclosure have been illustrated in connection with certain embodiments, there is no intent to limit the invention to such embodiments. On the contrary, the intention of this disclosure is to cover all modifications and embodiments falling fairly within the scope of the teachings of the disclosure.

We claim:

1. A towing tongue comprising:
an actuator with a first end and a second end;
a first and a second tongue members each with a proximate first end and a proximate second end;
a tongue hitch; and
a mount;
wherein the first end of the actuator is movably connected to the first tongue member and the second end of the actuator is movably connected to the second tongue member, wherein the tongue hitch is movably connected to the proximate first ends of the first and second tongue members, wherein the mount is movably connected to the proximate second ends of the first and second tongue members; and wherein the actuator is operable between a first and second operating position including at least one third operating position between the first and second operating position.

2. The towing tongue as recited in claim 1, wherein:
the tongue hitch includes a first and second aperture;
the first and second tongue members include corresponding first and second apertures proximate the first ends of the first and second tongue members, respectfully;
a first substantially vertical pivot axis is defined by a first hitch pin positioned within each of the first apertures associated with the tongue hitch and the first tongue member; and
a second substantially vertical pivot axis is defined by a second hitch pin positioned within each of the second apertures associated with the tongue hitch and the second tongue member.

3. The towing tongue as recited in claim 2, wherein the first and second tongue members are operable to be swung about the tongue hitch to any number of angular positions.

4. The towing tongue as recited in claim 1, wherein the first and second tongue members are substantially parallel to each other.

5. The towing tongue as recited in claim 1, wherein the actuator is a linear actuator.

6. The towing tongue as recited in claim 1, wherein the tongue hitch is connectable to a tow vehicle and wherein the mount is connectable to a towed implement.

7. The towing tongue of claim 1, wherein:
the mount comprises a first and second aperture;
the first and second tongue members include corresponding third and fourth apertures proximate the second ends of the first and second tongue members, respectfully;
a third substantially vertical pivot axis is defined by a first mount pin positioned within each of the first aperture associated with the mount and the third aperture associated with the first tongue member; and
a fourth substantially vertical pivot axis is defined by a second mount pin positioned within each of the second aperture associated with the mount and the fourth aperture associated with the second tongue member.

8. The towing tongue as recited in claim 7, wherein the first and second tongue members are operable to be swung about the mount to any number of angular positions.

9. The towing tongue as recited in claim 1, wherein a first actuator pin movably connects the first end of the actuator to the first tongue member, and a second actuator pin movably connects the second end of the actuator to the second tongue member.

10. The towing tongue as recited in claim 9, wherein a first spacer is placed between the first end of the actuator and the first tongue member, and a second spacer is placed between the second end of the actuator and the second tongue member.

11. A towing tongue comprising:
an actuator with a first end and a second end;
a first and second tongue members each with a proximate first end, a proximate second end, and an intermediate position;
a tongue hitch;
a mount; and
a strap with a first pivotal attachment, a second pivotal attachment, and a third pivotal attachment;
wherein the first tongue member further comprises a pivotal position for movably connecting the second end of the actuator between the proximate second end and the intermediate position, wherein the first end of the actuator is movably connected to the third pivotal attachment of the strap, wherein the first pivotal attachment of the strap is movably connected to the intermediate position of the second tongue member, and the second pivotal attachment of the strap is movably connected to the intermediate position of the first tongue member; wherein the tongue hitch is movably connected to the proximate first ends of the first and second tongue members, wherein the mount is movably connected to the proximate second ends of the first and second tongue members, and wherein the actuator is operable between a first and second operation position including at least one third operating position between the first and second operating position.

12. The towing tongue as recited in claim 11, wherein:
the tongue hitch includes a first and second aperture;
the first and second tongue members include corresponding first and second apertures proximate the first ends of the first and second tongue members, respectfully;
a first substantially vertical pivot axis is defined by a first hitch pin positioned within each of the first apertures associated with the tongue hitch and the first tongue member; and
a second substantially vertical pivot axis is defined by a second hitch pin positioned within each of the second apertures associated with the tongue hitch and the second tongue member.

13. The towing tongue as recited in claim 12, wherein the first and second tongue members are operable to be swung about the tongue hitch to any number of angular positions.

14. The towing tongue as recited in claim 12, wherein the first and second tongue members are substantially parallel to each other.

15. The towing tongue as recited in claim 11, wherein the actuator is a linear actuator.

16. The towing tongue as recited in claim 11, wherein the tongue hitch is connectable to a tow vehicle and wherein the mount is connectable to a towed implement.

17. The towing tongue of claim 13, wherein:
the mount comprises a first and second aperture;
the first and second tongue members include corresponding third and fourth apertures proximate the second ends of the first and second tongue members, respectfully;
a third substantially vertical pivot axis is defined by a first mount pin positioned within each of the first aperture associated with the mount and the third aperture associated with the first tongue member; and
a fourth substantially vertical pivot axis is defined by a second mount pin positioned within each of the second aperture associated with the mount and the fourth aperture associated with the second tongue member.

18. The towing tongue as recited in claim 17, wherein the first and second tongue members are operable to be swung about the mount to any number of angular positions.

19. The towing tongue as recited in claim 11, wherein a first actuator pin movably connects the first end of the actuator to the pivotal position on the first tongue; and a second actuator pin movably connects the second end of the actuator to the third pivotal attachment of the strap.

20. The towing tongue as recited in claim 16, wherein when the actuator is operating in the first operating position, the towed implement is in a first position with respect to the tow vehicle, when the actuator is operating in the second operating position, the towed implement is in a second position with respect to the tow vehicle, and when the actuator is operating in a third operating position, the towed implement is in a third position with respect to the tow vehicle.
